(19) United States
(12) Patent Application Publication
(10) Pub. No.: US 2023/0241922 A1
(43) Pub. Date: Aug. 3, 2023

(54) PNEUMATIC TIRE

(71) Applicant: The Yokohama Rubber Co., LTD., Tokyo (JP)

(72) Inventor: Atsuhito NAKANO, Kanagawa (JP)

(21) Appl. No.: 18/002,594

(22) PCT Filed: Feb. 8, 2021
(86) PCT No.: PCT/JP2021/004609

§ 371 Date: Dec. 20, 2022

(30) Foreign Application Priority Data
Jun. 25, 2020 (JP) 2020-109448

(51) Int. Cl. B60C 9/04; B60C 11/03; D02G 3/48

(52) U.S. Cl. CPC B60C 9/04; B60C 11/03; D02G 3/48; B60C 2011/0341; B60C 2009/0458

(57) ABSTRACT

In a pneumatic tire including a tread portion, a sidewall portion, a bead portion, a carcass layer mounted between a pair of bead portions, a plurality of main grooves extending in the tire circumferential direction and formed in the tread portion, and a plurality of land portions defined by the main grooves, the carcass layer includes a carcass cord formed of a polyester fiber cord, an elongation at break of the carcass cord is from 20% to 30%, and a groove area ratio SgA in a ground contact region of the tread portion is from 20% to 40%, a groove area ratio SgB in a center region of the tread portion satisfies a relationship 1.1≤SgB/SgA≤1.5, and a depth of the main groove included in the center region is from 5 mm to 8 mm.

### TECHNICAL FIELD

The present technology relates to a pneumatic tire provided with a carcass layer including an organic fiber cord and particularly relates to a pneumatic tire that can have improved shock burst resistance and steering stability on wet road surfaces while maintaining good steering stability on dry road surfaces, and have these performances in a highly compatible manner.

### BACKGROUND ART

A pneumatic tire generally includes a carcass layer mounted between a pair of bead portions, and the carcass layer is constituted by a plurality of reinforcing cords (carcass cords). Organic fiber cords are mainly used as the carcass cords. In particular, in a tire that requires excellent steering stability, high-rigidity rayon fiber cords may be used (see, for example, Japan Unexamined Patent Publication No. 2015-205666 A).

On the other hand, in recent years, since there has been an increasing demand for weight reduction of tires and reduction in rolling resistance, thinner rubber gauges in a tread portion have been considered. However, in the case of a tire provided with the carcass layer formed of the rayon fiber cords described above, there is a concern that shock burst resistance may decrease along with the reduction in the thickness of the tread portion. Shock burst resistance is the durability of a tire against damage caused by a large jolt received during travel, which causes the carcass to be damaged (shock burst), and for example, a plunger energy test (which is a test for measuring tire breakage energy when a tire is damaged by pressing a plunger with a predetermined size into a tread central portion) is an indicator.

Therefore, in order to improve shock burst resistance while ensuring steering stability on dry road surfaces as good as that when rayon fiber cords are used, the use of polyester fiber cords with predetermined physical properties as the carcass cords has been considered. On the other hand, when the reduction in the thickness of the tread portion and reduction in groove depth accompanying therewith are carried out by adopting such polyester fiber cords, steering stability on wet road surfaces may deteriorate.

### SUMMARY

The present technology provides a pneumatic tire that can have improved shock burst resistance and steering stability on wet road surfaces while maintaining good steering stability on dry road surfaces, and have these performances in a highly compatible manner.

A pneumatic tire according to the present technology includes a tread portion extending in a tire circumferential direction and having an annular shape, a pair of sidewall portions respectively disposed on both sides of the tread portion, a pair of bead portions each disposed on an inner side of the sidewall portions in a tire radial direction, a carcass layer mounted between the pair of bead portions, a plurality of main grooves extending in the tire circumferential direction and formed in the tread portion, and a plurality of land portions defined by the main grooves, in which the carcass layer includes a carcass cord formed of a polyester fiber cord, an elongation at break EB of the carcass cord being from 20% to 30%, and a groove area ratio SgA in a ground contact region of the tread portion is from 20% to 40%, a groove area ratio SgB in a center region of the tread portion satisfies a relationship 1.1≤SgB/SgA≤1.5, and a depth G of the main groove included in the center region is from 5 mm to 8 mm.

In the present technology, since the carcass cord included in the carcass layer is a polyester fiber cord having an elongation at break EB of from 20% to 30%, the rigidity can be maintained to be equal to or greater than that when a rayon fiber cord is used, and good steering stability can be exhibited on dry road surfaces and wet road surfaces. Further, since the carcass cord has the elongation at break EB described above, the carcass cord easily follows local deformation, the deformation during a plunger energy test (when the carcass cord is pressed by a plunger) can be sufficiently tolerated, and breakage energy can be improved. In other words, during travel, breakage durability against protrusion input of the tread portion is improved, so that shock burst resistance can be improved. Furthermore, by defining the groove area ratio SgA in the ground contact region of the tread portion, the groove area ratio SgB in the center region of the tread portion, and the depth G of the main groove included in the center region as described above, steering stability on dry road surfaces, steering stability on wet road surfaces, and shock burst resistance can be improved in a well-balanced manner. As a result, shock burst resistance and steering stability on wet road surfaces can be improved while maintaining good steering stability on dry road surfaces, and these performances can be provided in a highly compatible manner.

In the present technology, the relationship Tc>Te is preferably satisfied, where in at least one land portion included in the center region, a rubber thickness at a main groove side end portion of the land portion is Te, and a rubber thickness at a central portion of the land portion is Tc. By relatively increasing the rubber thickness Tc at the central portion of the land portion included in the center region in this manner, shock burst resistance can be effectively enhanced. Further, when ground contact is made, the central portion of the land portion comes into contact with the ground first; thus, drainage properties can be improved, improving steering stability on wet road surfaces.

The number of layers of the carcass layer in the center region is preferably one. As a result, tire weight can be reduced and rolling resistance can be reduced while ensuring good shock burst resistance.

In a case in which a plurality of belt layers including a belt cord inclined with respect to the tire circumferential direction are disposed on an outer circumferential side of the carcass layer in the tread portion, and a belt cover layer including a cover cord oriented in the tire circumferential direction is disposed on an outer circumferential side of the belt layers, the cover cord is preferably a hybrid cord of nylon fibers and aramid fibers, and the number of layers of the belt cover layer in the center region is preferably one. Accordingly, steering stability on dry road surfaces and wet road surfaces can be improved based on the rigidity of the belt cover layer, and tire weight and the rolling resistance can be reduced while ensuring good shock burst resistance.

Furthermore, in a case in which a plurality of belt layers including a belt cord inclined with respect to the tire circumferential direction are disposed on an outer circumferential side of the carcass layer in the tread portion, and a belt cover layer including a cover cord oriented in the tire circumferential direction is disposed on an outer circumferential side of the belt layers, the cover cord is preferably a nylon fiber cord, and the number of layers of the belt cover layer in the center region is preferably one or two. Accordingly, steering stability on dry road surfaces and wet road surfaces can be improved based on the rigidity of the belt cover layer, and tire weight and the rolling resistance can be reduced while ensuring good shock burst resistance.

An intermediate elongation EM of the carcass cord under a load of 1.0 cN/dtex is preferably 5.0% or less. Thus, the rigidity of the carcass cord can be sufficiently ensured, and steering stability on dry road surfaces and wet road surfaces can be effectively improved.

The carcass cord preferably has a fineness based on corrected mass CF of from 4000 dtex to 8000 dtex. Thus, the rigidity of the carcass cord can be sufficiently ensured, and steering stability on dry road surfaces and wet road surfaces can be effectively improved.

A twist coefficient K of the carcass cord represented by the following Formula (1) is preferably 2000 or more. Thus, the rigidity of the carcass cord can be sufficiently ensured, and steering stability on dry road surfaces and wet road surfaces can be effectively improved.

K=T×D^{1/2} (1)

where T is a cable twist count (counts/10 cm) of the carcass cord and D is a total fineness (dtex) of the carcass cord.

In the present technology, the ground contact region of the tread portion is a region corresponding to the ground contact width in a tire axial direction measured under the condition that a regular load is applied to the tire placed vertically on a plane in a state where the tire is mounted on a regular rim and inflated to a regular internal pressure. The center region of the tread portion is a region corresponding to 50% of the ground contact width centered on a tire equator. “Regular rim” is an air pressure defined by a standard for each tire according to a system of standards that includes standards with which tires comply, and refers to a maximum air pressure in the case of JATMA (The Japan Automobile Tyre Manufacturers Association, Inc.), the maximum value being listed in the table of “TIRE LOAD LIMITS AT VARIOUS COLD INFLATION PRESSURES” in the case of TRA (The Tire and Rim Association, Inc.), or “INFLATION PRESSURE” in the case of ETRTO (The European Tyre and Rim Technical Organisation). “Regular rim” is 180 kPa in a case where a tire is for a passenger vehicle. “Regular load” is a load defined by a standard for each tire according to a system of standards that includes standards with which tires comply, and refers to a maximum load capacity in the case of JATMA, the maximum value being listed in the table of “TIRE LOAD LIMITS AT VARIOUS COLD INFLATION PRESSURES” in the case of TRA, or “LOAD CAPACITY” in the case of ETRTO. “Regular load” corresponds to 88% of the loads described above in a case where a tire is for a passenger vehicle.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of the pneumatic tire in FIG. 1.

FIG. 3 is a cross-sectional view illustrating a land portion in a center region of the tread portion of the pneumatic tire in FIG. 1.

### DETAILED DESCRIPTION

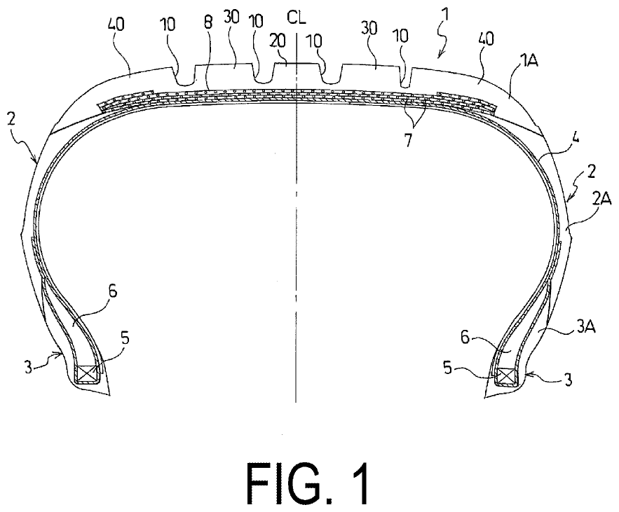

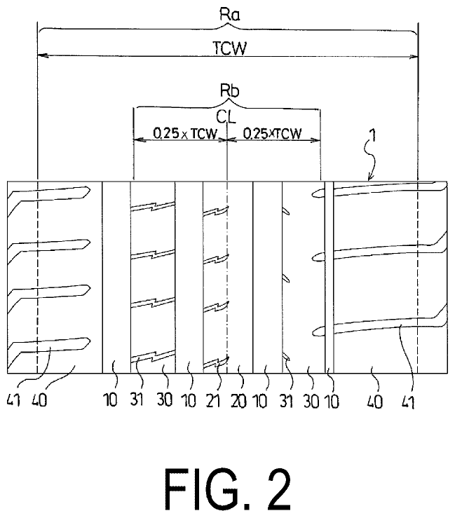

Configurations of the present technology will be described in detail below with reference to the accompanying drawings. FIGS. 1 to 3 illustrate a pneumatic tire according to an embodiment of the present technology. In FIG. 1, CL denotes a tire center position. In FIG. 2, TCW denotes a ground contact width.

As illustrated in FIG. 1, a pneumatic tire of the present embodiment includes a tread portion 1 extending in the tire circumferential direction and having an annular shape, a pair of sidewall portions 2, 2 respectively disposed on both sides of the tread portion 1, and a pair of bead portions 3, 3 each disposed on an inner side of the sidewall portions 2 in the tire radial direction.

A carcass layer 4 is mounted between the pair of bead portions 3, 3. The carcass layer 4 includes a plurality of carcass cords extending in the tire radial direction and is folded back around a bead core 5 disposed in each of the bead portions 3, from a tire inner side to a tire outer side. A bead filler 6 having a triangular cross-sectional shape and formed of a rubber composition is disposed on the outer circumference of the bead core 5.

On the other hand, a plurality of belt layers 7 are embedded on an outer circumferential side of the carcass layer 4 in the tread portion 1. The belt layers 7 include a plurality of belt cords inclined with respect to the tire circumferential direction, with the belt cords of the layers intersecting each other. In the belt layers 7, an inclination angle of the belt cord with respect to the tire circumferential direction is set within a range of, for example, from 10° to 40°. Steel cords are preferably used as the belt cords of the belt layers 7.

To improve high-speed durability, a belt cover layer 8, formed by disposing a cover cord at an angle of, for example, 5° or less with respect to the tire circumferential direction, is disposed on an outer circumferential side of the belt layers 7. As the belt cover layer 8, a full cover layer that covers the entire region of the belt layer 7 in the width direction, a pair of edge cover layers that locally cover both end portions of the belt layer 7 in the tire width direction, or a combination thereof can be provided. The belt cover layer 8 can be formed by helically winding a strip material made of at least a single cover cord bunched and covered with coating rubber, for example, in the tire circumferential direction. An organic fiber cord is preferably used as the cover cord of the belt cover layer 8.

Note that the tire internal structure described above represents a typical example for a pneumatic tire, but the pneumatic tire is not limited thereto. Additionally, a cap tread rubber layer 1A is disposed in the tread portion 1, a sidewall rubber layer 2A is disposed in each sidewall portion 2, and a rim cushion rubber layer 3A is disposed in each bead portion 3.

As illustrated in FIG. 2, the tread portion 1 is provided with a plurality of (in FIG. 2, four) main grooves 10 extending in the tire circumferential direction. The main groove 10 is a circumferential groove having a groove width of 4 mm or more, preferably in a range of 5 mm or more and 20 mm or less, and a groove depth in a range of 5 mm or more and 8 mm or less. Accordingly, in the tread portion 1, a center land portion 20 located on the tire center position CL (tire equator), a pair of intermediate land portions 30, 30 located on the outer side of the center land portion 20, and a pair of shoulder land portions 40, 40 located on the outer side of the pair of intermediate land portions 30 are defined. Further, lug grooves 21, 31 and 41 each extending in the tire width direction are formed in land portions 20, 30 and 40, respectively.

In the pneumatic tire described above, the carcass cord included in the carcass layer 4 is formed of a polyester fiber cord obtained by intertwining polyester fiber filament bundles. Elongation at break EB of the carcass cord (polyester fiber cord) is from 20% to 30%. Since the carcass cord (polyester fiber cord) having such physical properties is used for the carcass layer 4, rigidity equal to or greater than that when a conventional rayon fiber cord is used can be maintained, and good steering stability can be exhibited on dry road surfaces and wet road surfaces. Further, since the carcass cord has the elongation at break EB described above, the carcass cord easily follows local deformation, the deformation during a plunger energy test (when the carcass cord is pressed by a plunger) can be sufficiently tolerated, and breakage energy can be improved. In other words, during travel, breakage durability against protrusion input of the tread portion 1 is improved, so that shock burst resistance can be improved.

Here, when the elongation at break EB of the carcass cord is less than 20%, the effect of improving the shock burst resistance cannot be obtained. Conversely, when the elongation at break EB of the carcass cord is greater than 30%, intermediate elongation tends to be increased, horizontal rigidity of the tire is reduced, and the response at the time of steering is reduced, so that steering stability deteriorates. Specifically, the elongation at break EB of the carcass cord is preferably from 22% to 28%. Note that “elongation at break EB” is an elongation ratio (%) of a sample cord at breaking of the cord, which is obtained by conducting a tensile test with a length of specimen between grips being 250 mm and a tensile speed being 300±20 mm/minute in accordance with JIS (Japanese Industrial Standard) L1017 “Test methods for chemical fiber tire cords”.

Further, in the pneumatic tire described above, a groove area ratio SgA in a ground contact region Ra of the tread portion 1 is set within a range from 20% to 40%, a groove area ratio SgB in a center region Rb of the tread portion 1 satisfies the relationship 1.1≤SgB/SgA≤1.5, and a depth G of the main groove 10 included in the center region Rb is set within the range from 5 mm to 8 mm. The ground contact region Ra is a band region corresponding to a ground contact width TCW, and the center region Rb is a band region corresponding to 50% of the ground contact width TCW centered on the tire center position CL (tire equator). The groove area ratio SgA is the area ratio (%) of the groove elements occupying the ground contact region Ra on a road contact surface, and the groove area ratio SgB is the area ratio (%) of the groove elements occupying the center region Rb on the road contact surface.

By defining the groove area ratio SgA in the ground contact region Ra of the tread portion 1, the groove area ratio SgB in the center region Rb of the tread portion 1, and the depth G of the main groove included in the center region in this manner, steering stability on dry road surfaces, steering stability on wet road surfaces, and shock burst resistance can be improved in a well-balanced manner.

Here, when the groove area ratio SgA in the ground contact region Ra of the tread portion 1 is less than 20%, steering stability on wet road surfaces deteriorates due to a decrease in drainage properties, and conversely, when the groove area ratio SgA is more than 40%, steering stability on dry road surfaces deteriorates due to deterioration of the grips. Specifically, the groove area ratio SgA is preferably from 20% to 35%. Here, when the value of SgB/SgA is less than 1.1, the groove area in the center region Rb, which easily comes into contact with the ground, decreases, and thus steering stability on wet road surfaces deteriorates. Conversely, when the value of SgB/SgA is greater than 1.5, the groove area in the center region Rb, which easily comes into contact with the ground, increases, and thus steering stability on dry road surfaces deteriorates. Furthermore, rubber volume in the center region Rb decreases, counter force of the tread portion 1 is reduced upon impact, and stress concentration on the carcass layer 4 and the belt layer 7 increases, so that the shock burst resistance deteriorates. Furthermore, when the depth G of the main groove 10 included in the center region Rb is less than 5 mm, steering stability on wet road surfaces and shock burst resistance deteriorate, and conversely, when the depth G is greater than 8 mm, steering stability on dry road surfaces deteriorates.

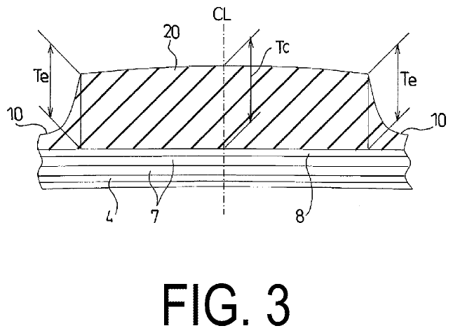

In the pneumatic tire described above, as illustrated in FIG. 3, in the center land portion 20 included in the center region Rb, when the rubber thickness at the main groove side end portion of the center land portion 20 is denoted as Te and the rubber thickness at the central portion of the center land portion 20 in the width direction is denoted as Tc, the relationship Tc>Te is preferably satisfied. That is, the center land portion 20 preferably has a contour shape that bulges smoothly toward the outer side in the tire radial direction such that the central portion is the highest in the tire meridian cross-section. The rubber thicknesses Te and Tc are the thicknesses of the cap tread rubber layer 1A located on the outer circumferential side of the belt layers 7 and the belt cover layer 8.

By relatively increasing the rubber thickness Tc at the central portion of the center land portion 20 included in the center region Rb in this manner, shock burst resistance can be effectively enhanced. Further, when ground contact is made, the central portion of the center land portion 20 comes into contact with the ground first; thus, drainage properties can be improved, improving steering stability on wet road surfaces. Note that such a contour shape can be applied to at least one land portion at least part of which is included in the center region Rb.

In the pneumatic tire described above, the number of layers of the carcass layer 4 in the center region Rb is preferably one (single layer). By minimizing the number of layers of the carcass layer 4 in this manner, tire weight can be reduced, and rolling resistance can be reduced. Moreover, since the carcass cord of the carcass layer 4 is formed of a polyester fiber cord having a predetermined elongation at break EB, good shock burst resistance can be ensured.

In the pneumatic tire described above, in the case in which the plurality of belt layers 7 including the belt cord inclined with respect to the tire circumferential direction are disposed on the outer circumferential side of the carcass layer 4 in the tread portion 1, and the belt cover layer 8 including the cover cord oriented in the tire circumferential direction is disposed on the outer circumferential side of the belt layers 7, the cover cord of the belt cover layer 8 is preferably a hybrid cord of nylon fibers and aramid fibers, and the number of layers of the belt cover layer 8 in the center region Rb is preferably one (single layer). In this way, steering stability on dry road surfaces and wet road surfaces can be improved based on the rigidity of the belt cover layer 8. Further, by minimizing the number of layers of the belt cover layer 8, tire weight can be reduced, and rolling resistance can be reduced. Moreover, when the number of layers of the belt cover layer 8 is small, the effect of improving shock burst resistance based on the carcass cord formed of a polyester fiber cord can be more effectively obtained.

Alternatively, in the pneumatic tire described above, in the case in which the plurality of belt layers 7 including the belt cord inclined with respect to the tire circumferential direction are disposed on the outer circumferential side of the carcass layer 4 in the tread portion 1, and the belt cover layer 8 including the cover cord oriented in the tire circumferential direction is disposed on the outer circumferential side of the belt layers 7, the cover cord of the belt cover layer 8 is preferably a nylon fiber cord, and the number of layers of the belt cover layer 8 in the center region Rb is preferably one (single layer) or two. In this way, steering stability on dry road surfaces and wet road surfaces can be improved based on the rigidity of the belt cover layer 8. Further, by minimizing the number of layers of the belt cover layer 8, tire weight can be reduced, and rolling resistance can be reduced. Moreover, when the number of layers of the belt cover layer 8 is small, the effect of improving shock burst resistance based on the carcass cord formed of a polyester fiber cord can be more effectively obtained.

In the pneumatic tire described above, the intermediate elongation EM of the carcass cord under a load of 1.0 cN/dtex is preferably 5.0% or less, and more preferably 4.0% or less. By using the carcass cord having such physical properties, the rigidity of the carcass cord can be sufficiently ensured, which is advantageous for improving steering stability on dry road surfaces and wet road surfaces. When the intermediate elongation EB of the carcass cord under a load of 1.0 cN/dtex is greater than 5.0%, the effect of improving steering stability is reduced due to a decrease in rigidity. Note that the “intermediate elongation under a load of 1.0 cN/dtex” is an elongation ratio (%) of a sample cord under a load of 1.0 cN/dtex, which is obtained by conducting a tensile test with a length of specimen between grips being 250 mm and a tensile speed being 300±20 mm/minute in accordance with JIS L1017 “Test methods for chemical fiber tire cords”.

In the pneumatic tire described above, the carcass cord preferably has a fineness based on corrected mass CF of from 4000 dtex to 8000 dtex, and more preferably from 5000 dtex to 7000 dtex. By using the carcass cord having such a fineness based on corrected mass CF, the rigidity of the carcass cord can be sufficiently ensured, which is advantageous for improving steering stability on dry road surfaces and wet road surfaces. When the fineness based on corrected mass CF of the carcass cord is less than 4000 dtex, the effect of improving steering stability is reduced. On the other hand, when the fineness based on corrected mass CF of the carcass cord is greater than 8000 dtex, the effect of improving shock burst resistance is reduced.

In the pneumatic tire described above, the carcass cord preferably has a thermal shrinkage rate of from 0.5% to 2.5%, and more preferably from 1.0% to 2.0%. By using the carcass cord having such a thermal shrinkage rate, the occurrence of kinking (twisting, folding, wrinkling, and collapsing in shape, and the like) in the carcass cord during vulcanization and deterioration in durability or a decrease in uniformity can be suppressed. When the thermal shrinkage rate of the carcass cord is less than 0.5%, kinking easily occurs during vulcanization, and thus it is difficult to satisfactorily maintain durability. When the thermal shrinkage rate of the carcass cord exceeds 2.5%, uniformity may deteriorate. Note that “thermal shrinkage rate” is a dry thermal shrinkage rate (%) of a sample cord measured when heating is performed at 150° C. for 30 minutes with a length of specimen being 500 mm in accordance with JIS L1017 “Test methods for chemical fiber tire cords”.

In the pneumatic tire described above, a twist coefficient K of the carcass cord represented by the following Formula (1) is preferably 2000 or more, and more preferably from 2100 to 2400. The twist coefficient K is a value of the carcass cord after dip treatment. By using the carcass cord having such a twist coefficient K, the rigidity of the carcass cord can be sufficiently ensured, which is advantageous for improving steering stability on dry road surfaces and wet road surfaces. Further, cord fatigue can be mitigated, and excellent durability can be ensured. In this case, when the twist coefficient K of the carcass cord is less than 2000, the effect of improving steering stability is reduced due to a decrease in rigidity.

K=T×D^{1/2} (1)

where T is a cable twist count (counts/10 cm) of the carcass cord and D is a total fineness (dtex) of the carcass cord.

The type of polyester fibers constituting the carcass cord is not particularly limited, and examples thereof include polyethylene terephthalate fibers (PET fibers), polyethylene naphthalate fibers (PEN fibers), polybutylene terephthalate fibers (PBT fibers), and polybutylenenaphthalate fibers (PBN fibers), with PET fibers being particularly suitable. When any of the fibers is used, steering stability and shock burst resistance can be provided in a highly compatible manner by the physical properties of the fibers. In particular, PET fibers, which are inexpensive, allow reduction in the cost of the pneumatic tire. In addition, workability in producing cords can be increased.

### Examples

Tires according to Conventional Example, Comparative Examples 1 to 7, and Examples 1 to 8 were manufactured. The pneumatic tires have a tire size of 275/40 ZR20 (106Y) and have the basic structure illustrated in FIGS. 1 and 2. For the tires were set, as indicated in Tables 1 and 2, the material of the carcass cord, the elongation at break EB of the carcass cord, the groove area ratio SgA in the ground contact region of the tread portion, the ratio SgB/SgA of the groove area ratio SgB in the center region of the tread portion to the groove area ratio SgA in the ground contact region of the tread portion, the depth G of the main groove included in the center region, the ratio Tc/Te of the rubber thickness Tc at the central portion of the center region to the rubber thickness Te at the main groove side end portion of the land portion of the center region, the number of layers of the carcass layer in the center region, the number of layers of the belt cover layer including the hybrid cord of nylon fibers and aramid fibers, the number of layers of the belt cover layer including the nylon fiber cord, the intermediate elongation EM of the carcass cord under a load of 1.0 cN/dtex, the fineness based on corrected mass CF of the carcass cord, and the twist coefficient K of the carcass cord.

The material of the carcass cord is indicated as “rayon” when rayon fiber cords were used and “PET” when polyethylene terephthalate fiber (PET fiber) cords were used.

The test tires were evaluated for shock burst resistance, steering stability on wet road surfaces, rolling resistance, and steering stability on dry road surfaces according to the following evaluation methods, and the results are shown together in Tables 1 and 2.

Shock Burst Resistance:

Each of the test tires was assembled on a wheel having a rim size of 20×9.5 J and inflated to an air pressure of 220 kPa. Tire braking tests (plunger braking tests) were performed by pressing a plunger having a plunger diameter of 19 mm±1.6 mm against the central portion of the tread at a loading speed (plunger pressing speed) of 50.0 mm±1.5 m/min in accordance with JIS K6302, and tire strength (tire breakage energy) was measured. Evaluation results are expressed as index values with the measurement value of Conventional Example being defined as 100. Larger index values indicate higher breakage energy and superior shock burst resistance.

Steering Stability on Wet Road Surfaces:

Each of the test tires was assembled on a wheel having a rim size of 20×9.5 J, inflated to an air pressure of 240 kPa, and mounted on a test vehicle (3L-class European car (sedan)). On a test course formed of wet road surfaces with a flat circuit, the test vehicle was driven at a speed of 60 km/h or more and 100 km/h or less, and sensory evaluation was performed for steering stability (steering characteristics when the test driver performs a lane change and cornering, and stability when the vehicle travels straight). Evaluation results are expressed as index values with the value of Conventional Example being defined as 100. Larger index values indicate superior steering stability on wet road surfaces.

Rolling Resistance:

Each of the test tires was assembled on a wheel having a rim size of 20×9.5 J and mounted on a rolling resistance tester provided with an 854 mm-radius drum, and pre-running was performed for 30 minutes with an air pressure of 250 kPa and a load of 5.80 kN at a speed of 80 km/h, after which rolling resistance was measured under the same conditions. Evaluation results are expressed as index values, using the reciprocals of the measurement values, with the value of Conventional Example being defined as 100. Larger index values indicate lower rolling resistance.

Steering Stability on Dry Road Surfaces:

Each of the test tires was assembled on a wheel having a rim size of 20×9.5 J, inflated to an air pressure of 240 kPa, and mounted on a test vehicle (3L-class European car (sedan)). On a test course formed of dry road surfaces with a flat circuit, the test vehicle was driven at a speed of 60 km/h or more and 100 km/h or less, and sensory evaluation was performed for steering stability (steering characteristics when the test driver performs a lane change and cornering, and stability when the vehicle travels straight). Evaluation results are expressed as index values with the value of Conventional Example being defined as 100. Larger index values indicate superior steering stability on dry road surfaces.

TABLE 1

| | Conventional | Example | Comparative | Comparative |
|---|---|---|---|---|
| | Example | 1 | Example 1 | Example 2 |
| Material of carcass cord | Rayon | PET | PET | PET |
| Elongation at break EB (%) of carcass cord | 15 | 20 | 34 | 20 |
| Groove area ratio SgA (%) | 15 | 30 | 15 | 50 |
| SgB/SgA | 1.6 | 1.3 | 1.6 | 1.6 |
| Depth G of main groove (mm) | 9 | 7 | 7 | 7 |
| Tc/Te | 1.0 | 1.0 | 1.0 | 1.0 |
| Number of layers of carcass layer in center region | 2 | 2 | 2 | 2 |
| Number of layers of belt cover layer (hybrid cords) | 0 | 0 | 0 | 0 |
| Number of layers of belt cover layer (nylon fiber cords) | 0 | 0 | 0 | 0 |
| Intermediate elongation EM (%) of carcass cord | 6 | 6 | 6 | 6 |
| Fineness based on corrected mass CF of carcass cord (dtex) | 3900 | 3900 | 3900 | 3900 |
| Twist coefficient K of carcass cord | 1900 | 1900 | 1900 | 1900 |
| Shock burst resistance (index value) | 100 | 104 | 110 | 98 |
| Steering stability on wet road surfaces (index value) | 100 | 102 | 98 | 105 |
| Rolling resistance (index value) | 100 | 100 | 100 | 100 |
| Steering stability on dry road surfaces (index value) | 100 | 101 | 96 | 96 |

| | Comparative | Comparative | Example | Example |
|---|---|---|---|---|
| | Example 3 | Example 4 | 2 | 3 |
| Material of carcass cord | PET | PET | PET | PET |
| Elongation at break EB (%) of carcass cord | 20 | 20 | 20 | 20 |
| Groove area ratio SgA (%) | 30 | 30 | 30 | 30 |
| SgB/SgA | 1.6 | 0.9 | 1.3 | 1.3 |
| Depth G of main groove (mm) | 7 | 7 | 7 | 7 |
| Tc/Te | 1.0 | 1.0 | 1.1 | 1.1 |
| Number of layers of carcass layer in center region | 2 | 2 | 2 | 1 |
| Number of layers of belt cover layer (hybrid cords) | 0 | 0 | 0 | 0 |
| Number of layers of belt cover layer (nylon fiber cords) | 0 | 0 | 0 | 0 |
| Intermediate elongation EM (%) of carcass cord | 6 | 6 | 6 | 6 |
| Fineness based on corrected mass CF of carcass cord (dtex) | 3900 | 3900 | 3900 | 3900 |
| Twist coefficient K of carcass cord | 1900 | 1900 | 1900 | 1900 |
| Shock burst resistance (index value) | 99 | 104 | 105 | 103 |
| Steering stability on wet road surfaces (index value) | 103 | 98 | 103 | 102 |
| Rolling resistance (index value) | 100 | 100 | 100 | 102 |
| Steering stability on dry road surfaces (index value) | 97 | 101 | 102 | 101 |

TABLE 2

| | Comparative | Example | Comparative | Example |
|---|---|---|---|---|
| | Example 5 | 4 | Example 6 | 5 |
| Material of carcass cord | PET | PET | PET | PET |
| Elongation at break EB (%) of carcass cord | 15 | 20 | 15 | 20 |
| Groove area ratio SgA (%) | 30 | 30 | 30 | 30 |
| SgB/SgA | 1.3 | 1.3 | 1.3 | 1.3 |
| Depth G of main groove (mm) | 7 | 7 | 7 | 7 |
| Tc/Te | 1.1 | 1.1 | 1.1 | 1.1 |
| Number of layers of carcass layer in center region | 1 | 1 | 1 | 1 |
| Number of layers of belt cover layer (hybrid cords) | 0 | 1 | 1 | 0 |
| Number of layers of belt cover layer (nylon fiber cords) | 0 | 0 | 0 | 1 |
| Intermediate elongation EM (%) of carcass cord | 6 | 6 | 6 | 6 |
| Fineness based on corrected mass CF of carcass cord (dtex) | 3900 | 3900 | 3900 | 3900 |
| Twist coefficient K of carcass cord | 1900 | 1900 | 1900 | 1900 |
| Shock burst resistance (index value) | 95 | 105 | 97 | 104 |
| Steering stability on wet road surfaces (index value) | 102 | 104 | 104 | 104 |
| Rolling resistance (index value) | 102 | 102 | 102 | 102 |
| Steering stability on dry road surfaces (index value) | 101 | 102 | 102 | 102 |

| | Comparative | Example | Example | Example |
|---|---|---|---|---|
| | Example 7 | 6 | 7 | 8 |
| Material of carcass cord | PET | PET | PET | PET |
| Elongation at break EB (%) of carcass cord | 15 | 20 | 20 | 20 |
| Groove area ratio SgA (%) | 30 | 30 | 30 | 30 |
| SgB/SgA | 1.3 | 1.3 | 1.3 | 1.3 |
| Depth G of main groove (mm) | 7 | 7 | 7 | 7 |
| Tc/Te | 1.1 | 1.1 | 1.1 | 1.1 |
| Number of layers of carcass layer in center region | 1 | 1 | 1 | 1 |
| Number of layers of belt cover layer (hybrid cords) | 0 | 1 | 1 | 1 |
| Number of layers of belt cover layer (nylon fiber cords) | 1 | 0 | 0 | 0 |
| Intermediate elongation EM (%) of carcass cord | 6 | 1 | 1 | 1 |
| Fineness based on corrected mass CF of carcass cord (dtex) | 3900 | 3900 | 6400 | 6400 |
| Twist coefficient K of carcass cord | 1900 | 1900 | 1900 | 2100 |
| Shock burst resistance (index value) | 96 | 105 | 105 | 105 |
| Steering stability on wet road surfaces (index value) | 104 | 105 | 106 | 107 |
| Rolling resistance (index value) | 102 | 102 | 102 | 102 |
| Steering stability on dry road surfaces (index value) | 102 | 103 | 104 | 105 |

As can be seen from Tables 1 and 2, the tires of Examples 1 to 8 had improved shock burst resistance and steering stability on wet road surfaces while maintaining good steering stability on dry road surfaces and were able to have these performances in a highly compatible manner, in comparison with Conventional Example. On the other hand, in the tire of Comparative Example 1, in particular, the elongation at break EB of the carcass cord was too large; thus, steering stability on dry road surfaces and wet road surfaces deteriorated. In the tire of Comparative Example 2, in particular, the groove area ratio SgA was too large; thus, steering stability on dry road surfaces and shock burst resistance deteriorated. In the tire of Comparative Example 3, since the ratio SgB/SgA was too large, steering stability on dry road surfaces and shock burst resistance deteriorated. In the tire of Comparative Example 4, since the ratio SgB/SgA was too small, steering stability on wet road surfaces deteriorated. In the tires of Comparative Examples 5 to 7, since the elongation at break EB of the carcass cords was too small, shock burst resistance deteriorated.

1. A pneumatic tire comprising:
a tread portion extending in a tire circumferential direction and having an annular shape, a pair of sidewall portions respectively disposed on both sides of the tread portion, a pair of bead portions each disposed on an inner side of the sidewall portions in a tire radial direction, a carcass layer mounted between the pair of bead portions, a plurality of main grooves extending in the tire circumferential direction and formed in the tread portion, and a plurality of land portions defined by the main grooves;
the carcass layer comprising a carcass cord formed of a polyester fiber cord, an elongation at break EB of the carcass cord being from 20% to 30%, and
a groove area ratio SgA in a ground contact region of the tread portion being from 20% to 40%, a groove area ratio SgB in a center region of the tread portion satisfying a relationship 1.1≤SgB/SgA≤1.5, and a depth G of the main groove included in the center region being from 5 mm to 8 mm.

2. The pneumatic tire according to claim 1, wherein a relationship Tc>Te is satisfied, where a rubber thickness at a main groove side end portion of the land portion is Te and a rubber thickness at a central portion of the land portion is Tc in at least one land portion included in the center region.

3. The pneumatic tire according to claim 1, wherein the number of layers of the carcass layer in the center region is one.

4. The pneumatic tire according to claim 1, wherein a plurality of belt layers comprising a belt cord inclined with respect to the tire circumferential direction are disposed on an outer circumferential side of the carcass layer in the tread portion, a belt cover layer comprising a cover cord oriented in the tire circumferential direction is disposed on an outer circumferential side of the belt layers, the cover cord is a hybrid cord of nylon fibers and aramid fibers, and the number of layers of the belt cover layer in the center region is one.

5. The pneumatic tire according to claim 1, wherein a plurality of belt layers comprising a belt cord inclined with respect to the tire circumferential direction are disposed on an outer circumferential side of the carcass layer in the tread portion, a belt cover layer comprising a cover cord oriented in the tire circumferential direction is disposed on an outer circumferential side of the belt layers, the cover cord is a nylon fiber cord, and the number of layers of the belt cover layer in the center region is one or two.

6. The pneumatic tire according to claim 1, wherein an intermediate elongation EM of the carcass cord under a load of 1.0 cN/dtex is 5.0% or less.

7. The pneumatic tire according to claim 1, wherein the carcass cord has a fineness based on corrected mass CF of from 4000 dtex to 8000 dtex.

8. The pneumatic tire according to claim 1, wherein a twist coefficient K of the carcass cord represented by K=T/D^{1/2} is 2000 or more,
where T is a cable twist count (counts/10 cm) of the carcass cord and D is a total fineness (dtex) of the carcass cord.

9. The pneumatic tire according to claim 2, wherein the number of layers of the carcass layer in the center region is one.

10. The pneumatic tire according to claim 9, wherein a plurality of belt layers comprising a belt cord inclined with respect to the tire circumferential direction are disposed on an outer circumferential side of the carcass layer in the tread portion, a belt cover layer comprising a cover cord oriented in the tire circumferential direction is disposed on an outer circumferential side of the belt layers, the cover cord is a hybrid cord of nylon fibers and aramid fibers, and the number of layers of the belt cover layer in the center region is one.

11. The pneumatic tire according to claim 10, wherein a plurality of belt layers comprising a belt cord inclined with respect to the tire circumferential direction are disposed on an outer circumferential side of the carcass layer in the tread portion, a belt cover layer comprising a cover cord oriented in the tire circumferential direction is disposed on an outer circumferential side of the belt layers, the cover cord is a nylon fiber cord, and the number of layers of the belt cover layer in the center region is one or two.

12. The pneumatic tire according to claim 11, wherein an intermediate elongation EM of the carcass cord under a load of 1.0 cN/dtex is 5.0% or less.

13. The pneumatic tire according to claim 12, wherein the carcass cord has a fineness based on corrected mass CF of from 4000 dtex to 8000 dtex.

14. The pneumatic tire according to claim 13, wherein a twist coefficient K of the carcass cord represented by K=T×D^{1/2} is 2000 or more, where T is a cable twist count (counts/10 cm) of the carcass cord and D is a total fineness (dtex) of the carcass cord.
